(19) United States
(12) Patent Application Publication
(10) Pub. No.: US 2025/0069490 A1
(43) Pub. Date: Feb. 27, 2025

(54) SYSTEM AND METHOD FOR MONITORING OPERATIONAL AREA

(71) Applicant: SAUDI ARABIAN OIL COMPANY, Dhahran (SA)

(72) Inventors: Khaled M. Al-Shahrani, Dhahran (SA); Saeed O. Al-Sobaiey, Dhahran (SA)

(73) Assignee: SAUDI ARABIAN OIL COMPANY, Dhahran (SA)

(21) Appl. No.: 18/456,356

(22) Filed: Aug. 25, 2023

(51) Int. Cl. G08B 21/18; G08B 7/06; G08B 21/02; H05B 45/20

(52) U.S. Cl. CPC G08B 21/182; G08B 7/06; G08B 21/02; H05B 45/20

(57) ABSTRACT

A system, device, and method for monitoring an operational area include a temperature sensor configured to measure an ambient temperature of the operational area in real time; a humidity sensor configured to measure a humidity of the operational area in real time; and a controller communicatively coupled to the temperature sensor and the humidity sensor. The controller is configured to calculate a heat index based on measurements including the ambient temperature and the humidity, determine a danger category based on a comparison of the heat index with a preset threshold, and provide an alert corresponding to the danger category.

### BACKGROUND

The health and safety of people working in hot and humid environments can be at risk. For example, operators working outdoors (e.g., construction, cleaning, security, landscaping, etc.) or indoors without air conditioning are at risk of heat stroke or heat stress.

Current practice includes reducing heat-related illness in the workplace through engineering and administrative (work practice) controls. An engineering control could be a change in the design of the workplace that reduces exposure to heat, such as increasing air velocity, using reflective or heat-absorbing shields or barriers, reducing steam leaks, wet floor, or humidity, etc. Administrative controls are changes in tasks or schedules to reduce heat stress, such as limiting working time in the heat and/or increasing recovery time in a cool area, using a buddy system where workers monitor each other for signs of heat-related illness, requiring workers to perform self-monitoring, and establishing a working group (i.e. workers, a qualified health care provider, and a safety manager) to make decisions about self-monitoring options and standard operating procedures.

Therefore, it is beneficial to provide and improve devices, systems, or methods to assist in implementation of engineering and/or administrative controls in hot and humid operational areas to protect workers from the risk of heat stroke or heat stress.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect of one or more embodiments of the present disclosure, a system for monitoring an operational area is provided, the system comprising: a temperature sensor configured to measure an ambient temperature of the operational area in real time; a humidity sensor configured to measure a humidity of the operational area in real time; and a controller communicatively coupled to the temperature sensor and the humidity sensor, wherein the controller is configured to: calculate a heat index based on measurements including the ambient temperature and the humidity; determine a danger category based on a comparison of the heat index with a preset threshold; and provide an alert corresponding to the danger category.

In another aspect of one or more embodiments of the present disclosure, a device for monitoring an operational area is provided, the device comprising the system as discussed above. In addition, the device may comprise a housing for being carried by an operator working in the operational area, wherein the temperature sensor and the humidity sensor are embedded in the housing and exposed to ambient air of the operational area.

In a further aspect of one or more embodiments of the present disclosure, a method is provided for monitoring an operational area, the method comprising: receiving an ambient temperature of the operational area in real time; receiving a humidity of the operational area in real time; calculating a heat index based on measurements including the ambient temperature and the humidity; determining a danger category based on a comparison of the heat index with a preset threshold; and providing an alert corresponding to the danger category.

In light of the structure and functions described above, embodiments of the disclosure may include respective means adapted to carry out various steps and functions defined above in accordance with one or more aspects and any one of the embodiments of one or more aspects described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 is a block diagram of a system for monitoring an operational area.

FIG. 2 is a chart showing the determination of heat indexes based on the air temperature and the relative temperature.

FIG. 3 is a chart showing the determination of danger categories and alerts according to preset thresholds corresponding to heat indexes.

FIG. 4 is a schematic diagram showing a device for monitoring an operational area.

FIG. 5 is a block diagram of a method for monitoring an operational area.

### DETAILED DESCRIPTION

In the following detailed description, numerous specific details are set forth in order to provide a more thorough understanding of the disclosure. Reference will now be made in detail to various embodiments of the subject matter, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope of the various embodiments as defined by the appended claims. Furthermore, embodiments may be practiced without these specific details. In other instances, well known methods, procedures, components, and circuits have not been described in detail so as not to unnecessarily obscure aspects of the described embodiments.

Throughout the application, ordinal numbers (e.g., first, second, third, etc.) may be used as an adjective for an element (i.e., any noun in the application). The use of ordinal numbers is not intended to imply or create any particular ordering of elements nor to limit any element to being only a single element unless expressly disclosed, such as using the terms “before”, “after”, “single”, and other such terminology. Rather, the use of ordinal numbers is to distinguish among the elements. By way of an example, a first element is distinct from a second element, and the first element may encompass more than one element and succeed (or precede) the second element in an ordering of elements.

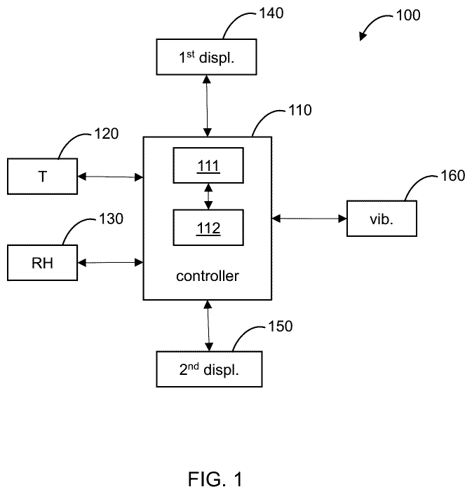

FIG. 1 is a block diagram of a system 100 for monitoring an operational area according to one or more embodiments. An operational area may be any area where a worker performs operations of any type, such as outdoor areas (e.g., work areas for construction, cleaning, security, landscaping, etc.) or indoor areas (e.g., factories, mines, etc.).

As shown in FIG. 1, the system 100 includes a controller 110, a humidity sensor 120, a temperature sensor 130, a first display 140, a second display 150, and a vibrator 160. The controller 100 may include a processor 111 and a storage 112 which may include a read-only memory (ROM), in which various programs are stored, and a random-access memory (RAM), in which various data are temporarily stored. The processor 111 loads programs stored in the ROM into the RAM and executes various processing in cooperation with the RAM. The controller 110 communicates with and receives information from the temperature sensor 120 and the humidity sensor 130. The controller 110 further communicates with and sends control signals to the first display 140, the second display 150, and the vibrator 160.

In one or more embodiments, the temperature sensor (T) 120 is configured to capture real-time information about the ambient temperature in an operational area and sends it to the controller 110, and the humidity sensor (RH) 130 is configured to capture real-time information on the humidity of the operational area and sends it to the controller 110. The controller 110 receives the real-time ambient temperature from the temperature sensor 120 and the real-time humidity from the humidity sensor 130 and calculates a heat index based on measurements including the ambient temperature and the humidity. Further, the controller 110 determines a danger category based on a comparison of the heat index with a preset threshold and provides an alert corresponding to the danger category.

The controller 110 may be programed in any suitable way to calculate or determine the heat index. The heat index, also known as the apparent temperature, is what the temperature feels like to the human body when the relative humidity is combined with the air temperature. It has important implications for the human body's comfort. When the body gets too hot, it begins to perspire or sweat to cool itself off. If the perspiration is not able to evaporate, the body cannot regulate its temperature. Evaporation is a cooling process. When perspiration evaporates off the body, it effectively reduces the body's temperature. When the atmospheric moisture content (i.e., relative humidity) is high, the rate of evaporation from the body decreases. In other words, the human body feels warmer in humid conditions. The opposite is true when the relative humidity decreases because the rate of perspiration increases. The body feels cooler in dry conditions. There is a direct relationship between the air temperature and relative humidity and the heat index, meaning that as the air temperature and relative humidity increase (decrease), the heat index increases (decreases).

As an example, the controller 110 may be programed to calculate or determine the heat index based on the following formula:

Heat Index=−42.379+2.04901523T+10.14333127RH−0.22475541TRH−6.83783×10^{-3T}2−5.481717×10^{-2RH}2+1.22874×10^{-3T}2RH+8.5282×10^{-4TRH}2−1.99×10^{-6T}2RH\hat{ }2,

where T is the air temperature in degrees Fahrenheit and RH is the relative humidity expressed as a percentage.

It is recognized that since heat index values are devised for shady, light wind conditions, exposure to full sunshine can increase heat index values by up to 15° F. Therefore, the formula may be adjusted by taking other considerations into account when programing the controller for calculating the heat index.

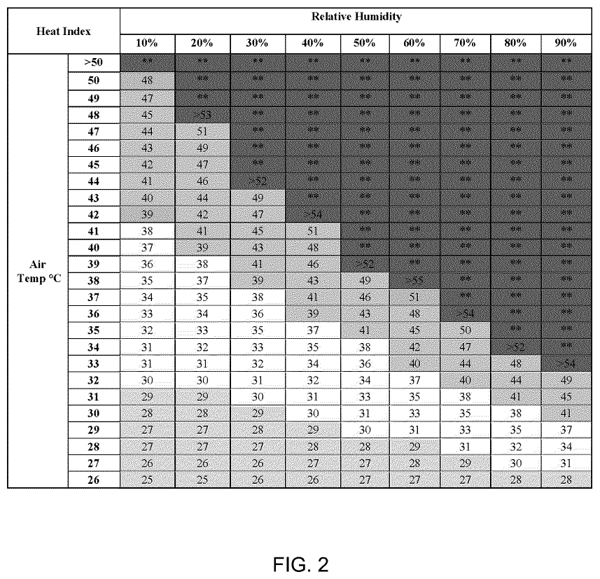

As another example, FIG. 2 shows a chart which may be programmed in the controller 110 to determine the heat index based on the air temperature and the relative humidity. For example, when the air temperature received in real time from the temperature sensor 120 is in the range of 49 to 50 Celsius and the relative humidity received in real time from the humidity sensor 130 is less than 10%, the processor may determine that the heat index in the operational area is currently 47. As another example, when the air temperature received in real time from the temperature sensor is in the range of 26-27 degrees Celsius and the relative humidity received in real time from the humidity sensor is less than 10%, the processor may determine that the heat index in the operational area is currently 25. As yet another example, when the air temperature received in real time from the temperature sensor is in the range of 26-27 degrees Celsius and the relative humidity received in real time from the humidity sensor is greater than 90%, the processor may determine that the heat index in the operational area is currently 28. The chart in FIG. 2 is intended to be illustrative, showing only part of possible air temperatures, relative humidities and heat indexes. Meanwhile, some values of heat index in the chart are shown with dots, but in actual applications may be given as true values of heat index.

A danger category herein refers to the level of risk a worker will be exposed to due to the heat index or apparent temperature. The controller may be programed in any suitable way to calculate or determine a danger category and provide an alert corresponding to the danger category. As one example, the controller determines a danger category based on a comparison of the heat index with a preset threshold.

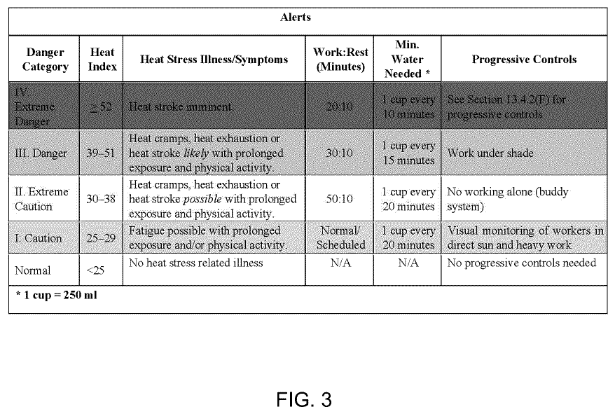

FIG. 3 is a chart showing five danger categories defined with preset thresholds of the heat indexes. As shown in the chart, the danger categories comprise one of the following: extreme danger when the heat index is 52 or greater; danger when the heat index is between 39 and 51; extreme caution when the heat index is between 30 and 38; caution when the heat index is between 25 and 29; normal when the heat index is less than 25.

For each of the danger categories, alerts may be provided in one or more forms by the controller, such as visual, haptic, or acoustic information, or any combination thereof, to be noticed by the user in the operational area.

In one or more embodiments, the alert may include caution messages and recommendations for the real-time danger category. As illustrated in FIG. 3, the caution messages may include heat stress symptoms, period of work and rest, minimum water needed and progressive controls, or other caution messages as necessary or appropriate according to medical practices or occupational safety regulations. The caution messages may be controlled by the processor to be shown, for example, in the second display in the form of texts or graphics.

In one or more embodiments, the alerts may include different colors for different danger categories determined by the controller. For example, as shown in FIG. 2 and FIG. 3, the controller may control the first display to show a red light for the danger category of extreme danger when the heat index is 52 or greater, an orange light for the danger category of danger when the heat index is between 39 and 51, a yellow light for the danger category of extreme caution when the heat index is between 30 and 38, a green light for the danger category of caution when the heat index is between 25 and 29, and no light for the danger category of normal when the heat index is less than 25.

In one or more embodiments, the alerts may be for the vibrator to vibrate for a duration when the danger category changes from a preceding danger category. For example, the vibrator vibrates when the heat index increases and the danger category now change from ‘Caution’ to ‘Extreme Caution’ or from ‘Extreme Caution to ‘Danger’ zone and so on. Further, the duration for the vibrator to vibrate varies according to the danger category. For example, the duration of vibration increases when the heat index increases and the danger category changes from ‘Caution’ to ‘Extreme Caution’ or from ‘Extreme Caution to ‘Danger’ and so on.

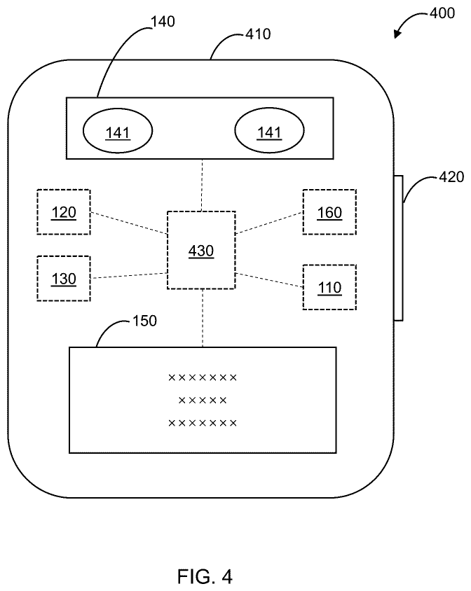

FIG. 4 is a schematic diagram of a device 400 for monitoring an operational area according to one or more embodiments. The device 400 may be constructed to be portable and can be carried by an operator while performing operation in an operational area. For example, the device 400 includes a housing 410 with a clip 420 by which the device 400 can be clipped to an operator's shirt or coveralls such that the device is exposed to ambient air when the device is used with an operator in an operational area.

In one or more embodiments, the device 400 may include the system 100 as discussed above. As shown in FIG. 4, the device includes a controller 110, a temperature sensor 120, a humidity sensor 130, and a vibrator 160 in the housing 410, and the device further includes a first display 140 and a second display 150 on the housing 410. There is further a battery 430 in the housing for providing power to the controller 110, the temperature sensor 120, the humidity sensor 130, the first display 140, the second display 150, and the vibrator 160.

Sensors, including but not limited to the temperature sensor 130, and the humidity sensor 120 may be included in the housing to provide comprehensive information about the environment in the operational area.

The temperature sensor 120 and the humidity sensor 130 may be embedded or mounted in the housing 410 and communicate through windows in the housing 410 to contact the air in a working space. Other suitable means may also be used to provide the humidity sensor 120 and the temperature sensor 130 for measuring an ambient temperature and a relative humidity of the operational area in real time. Further, though not shown, it is envisaged that various other detectors may be provided in the housing to perform other measures, such as signal detectors (e.g., WiFi, Bluetooth, etc.), location detectors (e.g., GPS sensor), and the like.

The temperature sensor 120 may include circuitry that measures the temperature of the environment and converts the input data into electronic data for recording. monitoring, or signaling temperature changes. There are ways known in the art for providing the temperature sensors. In an embodiment, the temperature sensor is a contact temperature sensor that requires direct contact with the air in the operational area. In another embodiment, the temperature sensor is a non-contact temperature sensor that indirectly measures the temperature remotely by detecting the IR energy emitted by the air in the operational area and sending a signal to a calibrated electronic circuit that determines the temperature. In another embodiment, the temperature sensor is an integrated silicon thermistor that can be incorporated in a circuit board in the housing.

The humidity sensor 130 is an electronic device that can measure the amount of water vapor or moisture in the air. Humidity affects the performance, comfort, and health of humans, animals, and machines. Therefore, humidity sensors have many applications in different fields, such as meteorology, agriculture, medicine, industry, and consumer electronics etc. The humidity sensor may be chosen as any type known in the art to measure the humidity in the air in the operational area, and the humidity may be provided as an absolute value or relative value as required. For example, a capacitive humidity sensor, a resistive humidity sensor or a thermal humidity sensor may be used for measuring the relative or absolute humidity in the air in the operational area. The humidity sensor may also be integrated with other sensors, such as temperature, pressure, or gas sensors, to provide more comprehensive information.

Displays, including but not limited to the first display 140 and the second display 150, may be provided in the device 400 for showing different types of alerts to the users corresponding to the heat index and/or the danger categories. For example, a first display 140 may be provided on the housing 410, which includes one or more LED lights 141 for indicating the working status of the device, and one or more LED lights 141 with different colors for indicating different information about the environment. A second display 150 may be provided on the housing 410 for showing information with text or graphics. The second display 150 may be of any known type which may be used to display various graphical user interfaces, images, videos, or other contents. In addition, a vibrator 160 may be provided in the housing 410 to give messages by vibration for different duration of time. Though not shown, it is envisaged that various other means may be provided in the housing 410 to provide visual, haptic, or acoustic information, or any combination thereof to the user, such as speaker(s) and the like.

The controller 110 is provided in the housing 410 for controlling the operation of the device 400. The controller 110 may include a processor which may be any type of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor, and the like) and the like, which may directly or indirectly facilitate execution of program code or program instructions. In addition, the processor may enable the execution of multiple programs, threads, and codes.

The controller 110 may also include memories for storing methods, codes, instructions, and programs, as described herein and elsewhere, such as a read-only memory (ROM), in which various control programs are stored; and a random access memory (RAM), in which various control data are temporarily stored. The techniques additionally, or alternatively, may be realized at least in part by a processor-readable communication medium that carries or communicates code in the form of instructions or data structures and that can be accessed, read, and/or executed by a computer or other processor.

The device 400 may also include a battery 430 or other power source for providing power to electrical elements including the temperature sensor 120, a humidity sensor 130, the first display 140, the second display 150, the vibrator 160, the controller 110, etc. A primary battery, also known as a disposable battery for being designed to be used once and discarded, may be used in the device. Examples of primary batteries may include alkaline batteries, zinc-carbon batteries, and lithium batteries. Alternatively, a secondary battery, also known as a rechargeable battery for being recharged with electricity and reused multiple times, may be used in the device. Examples of secondary batteries may include lead-acid batteries, nickel-cadmium batteries, nickel-metal hydride batteries, and lithium-ion batteries. For example, the battery can be recharged wirelessly, and can be used for more than 48 hours on a single charge.

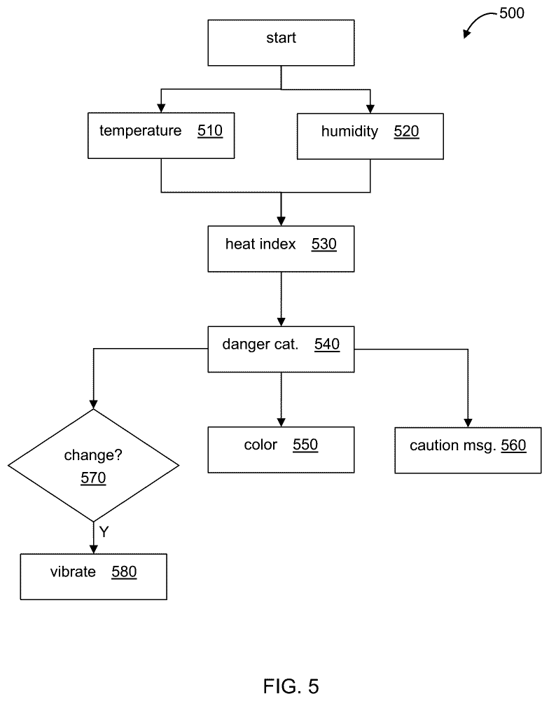

FIG. 5 is a block diagram of a method 500 for monitoring an operational area according to one or more embodiments.

As shown in FIG. 5, to start the method, a user (i.e., an operator) turns on the device, checks that the device is in fully charged condition, which may be indicated by an LED light in the first display. Then, the user clips the device onto the shirt/coveralls where it will be exposed to the ambient air. It is important that the device shall not be kept inside the pocket, but needs to be positioned such that the device, especially the sensors, is exposed to ambient air when the device is used with an operator in an operational area.

Once the device is started, the temperature sensor and the humidity sensor will periodically and repeatedly perform measurements, as shown in block 510 and block 520. and the measurements regarding the ambient temperature of the operational area and a humidity of the operational area will be sent to the controller in real time.

Then, in block 530, the controller receives the real-time measurements from the sensors, including the ambient temperature and the humidity, and calculates a heat index based on the measurements, including the ambient temperature, the humidity, and other measurements when possible.

As discussed above, the controller may be programed in any suitable way to calculate or determine the heat index. In one or more embodiments, the controller may be programed to calculate the heat index using the following formula:

Heat Index=−42.379+2.04901523T+10.14333127RH−0.22475541TRH−6.83783×10^{-3T}2−5.481717×10^{2RH}2+1.22874×10^{-3T}2RH+8.5282×10^{-4TRH}2−1.99×10^{-6T}2RH\hat{ }2,

where T is the air temperature in degrees Fahrenheit and RH is the relative humidity expressed as a percentage.

Meanwhile, this formula may be adjusted by factoring in other considerations when programing the controller for calculating the heat index.

In one or more embodiments, the controller may be programmed to determine the heat index according to a chart as shown in FIG. 3. For example, when the air temperature received in real time from the temperature sensor is in the range of 49-50 degrees Celsius and the relative humidity received in real time from the humidity sensor is less than 10%, the processor may determine that the heat index in the operational area is currently 47. As another example, when the air temperature received in real time from the temperature sensor is in the range of 26-27 degrees Celsius and the relative humidity received in real time from the humidity sensor is less than 10%, the processor may determine that the heat index in the operational area is currently 25. As yet another example, when the air temperature received in real time from the temperature sensor is in the range of 26-27 Celsius and the relative humidity received in real time from the humidity sensor is greater than 90%, the processor may determine that the heat index in the operational area is currently 28.

Further in block 540, the controller determines a danger category according to a preset threshold corresponding to the heat index. Multiple danger categories may be preset according to the effects of the indexes on the safety and health of an operator. Each of the multiple danger categories is set with a range of heat indexes determined by thresholds. The threshold may be set considering many factors, for example, environmental factors, metabolic heat from the tasks being performed etc. The controller may be programed in any suitable way to calculate or determine the danger categories. As discussed above with reference to FIG. 4, the controller may determine that the danger categories comprise one of the following: extreme danger when the heat index is 52 or greater; danger when the heat index is between 39 and 51; extreme caution when the heat index is between 30 and 38; caution when the heat index is between 25 and 29; normal when the heat index is less than 25.

Further, the controller may provide alerts corresponding to the danger category. The alerts may include any appropriate warnings and occupational safety and health recommendations.

In one or more embodiments, as in block 550, the controller may control the first display to display a color indicative of the danger category, and further the color displayed by the first display may vary according to the danger category. For example, the controller may control the first display to show a red light for the danger category of extreme danger when the heat index is 52 or greater, an orange light for the danger category of danger when the heat index is between 39 and 51, a yellow light for the danger category of extreme caution when the heat index is between 30 and 38, a green light for the danger category of caution when the heat index is between 25 and 29, and no light for the danger category of normal when the heat index is less than 25.

In one or more embodiments, as in block 560, the controller may control the second display to display a caution message corresponding to the danger category. The caution message may include a variety of recommendations for preventing heat stress among workers. In one or more examples, the caution messages may include heat stress symptoms, period of rest, minimum water requirement and progressive controls, or other caution messages as necessary or appropriate according to medical practice or work safety regulations. The caution messages may be controlled by the processor to be shown, for example, in the second display in the form of text or graphics.

In one or more embodiments, as in block 570, the controller may determine whether the danger category changes from a preceding danger category. When the controller determines the danger category changes from a preceding danger category, it controls a vibrator to vibrate for a duration, as in block 580. The alerts may include a different duration of vibration for a present danger category when the present danger category changes from a preceding danger category. For example, the vibrator vibrates when the heat index increases the danger category changes from ‘Caution’ to ‘Extreme Caution’ or from ‘Extreme Caution to ‘Danger’ zone and so on. The duration for the vibrator to vibrate may vary according to the danger category. For example, the duration of vibration increases when the heat index increases and the danger category changes from ‘Caution’ to ‘Extreme.’

It is envisaged that the various other alerts may be provided by the controller to provide visual, haptic, or acoustic information, or any combination thereof, to the user, such as speaker(s) and the like.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. One skilled in the art may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

Embodiments described herein may be discussed in the general context of processor-executable instructions residing on some form of non-transitory processor- readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

What is claimed is:

1. A system for monitoring an operational area, the device comprising:
a temperature sensor configured to measure an ambient temperature of the operational area in real time;
a humidity sensor configured to measure a humidity of the operational area in real time; and
a controller communicatively coupled to the temperature sensor and the humidity sensor, the controller being configured to:
calculate a heat index based on measurements including the ambient temperature and the humidity;
determine a danger category based on a comparison of the heat index with a preset threshold; and
provide an alert corresponding to the danger category.

2. The system of claim 1, wherein
the danger category includes one or more of the following:
extreme danger when the heat index is 52 or larger; danger when the heat index is between 39 and 51; extreme caution when the heat index is between 30 and 38; caution, when the heat index is between 25 and 29; and normal, when the heat index is below 25.

3. The system of claim 1, the device further comprising:
a first display communicatively coupled to the controller;
wherein the controller is further configured to control the first display to display a color indicative of the danger category.

4. The system of claim 3, wherein
the color displayed by the first display varies according to the danger category.

5. The system of claim 3, wherein
the first display comprises multiple LED lights, wherein each of the multiple LED lights is configured to radiate a light indicative of a corresponding danger category and the color of the light radiated from each of the multiple LED lights is different from each other.

6. The system of claim 1, the device further comprising:
a second display communicatively coupled to the controller;
wherein the controller is further configured to control the second display to display a caution message corresponding to the danger category.

7. The system of claim 1, wherein
the caution message includes information about one or more of the following:
a recommended work duration; a recommended reset duration; a recommended water consumption; and a recommended progressive control.

8. The system of claim 1, the device further comprising
a vibrator communicatively coupled to the controller;
wherein the controller is further configured to control the vibrator to vibrate for a duration when the danger category changes from a preceding danger category.

9. The system of claim 1, wherein
the duration for the vibrator to vibrate varies according to the danger category.

10. A device for monitoring an operational area, the device comprising the system of claim 1.

11. The device of claim 10, the device further comprising:
a housing for being carried by an operator working in the operational area;
wherein the temperature sensor and the humidity sensor are embedded in the housing and exposed to ambient air of the operational area.

12. A method for monitoring an operational area, the method comprising:
receiving an ambient temperature of the operational area in real time;
receiving a humidity of the operational area in real time;
calculating a heat index based on measurements including the ambient temperature and the humidity;
determining a danger category based on a comparison of the heat index with a preset threshold; and
providing an alert corresponding to the danger category.

13. The method of claim 12, wherein
the danger category includes one or more of the following:
extreme danger when the heat index is 52 or higher; danger when the heat index is between 39 and 51; extreme caution when the heat index is between 30 and 38; caution, when the heat index is between 25 and 29; and normal, when the heat index is below 25.

14. The method of claim 12, wherein
the alert is provided by controlling a first display to display a color indicative of the danger category.

15. The method of claim 14, wherein
the color displayed by the first display varies according to the danger category.

16. The method of claim 14, wherein
the first display comprises multiple LED lights, wherein each of the multiple LED lights is configured to radiate a light indicative of a corresponding danger category and the color of the light radiated from each of the multiple LED lights is different from each other.

17. The method of claim 12, wherein
the alert is provided by controlling a second display to display a caution message corresponding to the danger category.

18. The method of claim 12, wherein
the caution message includes information about one or more of the following:
a recommended work duration; a recommended reset duration; a recommended water consumption; and a recommended progressive control.

19. The method of claim 12, wherein
the alert is provided by controlling a vibrator to vibrate for a duration when the danger category changes from a preceding danger category.

20. The method of claim 12, wherein
the duration for the vibrator to vibrate varies according to the danger category.
